(19) United States
(12) Patent Application Publication
(10) Pub. No.: US 2014/0063817 A1
(43) Pub. Date: Mar. 6, 2014

(54) Lighting Device

(71) Applicant: Christian Bartenbach, Aldrans (AT)

(72) Inventor: Christian Bartenbach, Aldrans (AT)

(73) Assignee: BARTENBACH HOLDING GMBH, Aldrans (AT)

(21) Appl. No.: 14/000,727

(22) PCT Filed: Feb. 20, 2012
(86) PCT No.: PCT/EP12/00738

§ 371 Date: Sep. 22, 2013

(30) Foreign Application Priority Data
Feb. 23, 2011 (DE) 10 2011 012 130.7

(51) Int. Cl. F21K 99/00; F21V 7/00

(52) U.S. Cl. CPC F21K 9/54; F21V 7/0091
USPC 362/311.02; 362/326; 362/329

(57) ABSTRACT

A lighting device, in particular in the form of a ceiling, wall, floor or outside light, having a punctiform light source, preferably in the form of an LED, and a lens assigned to the light source, which has a light entry recess in the form of a bowl or blind hole, which deflects at least part of the incident light, indirectly or directly, onto a totally reflecting and/or mirrored lateral surface, which in turn deflects the light onto a light exit surface, which forms a front side of the lens located opposite the light entry recess. The lateral surface of the lens, which deflects the light coming directly or indirectly from the light entry surface onto the light exit surface by means of total reflection and/or mirroring, is provided with a multiplicity of facets.

### CROSS-REFERENCE TO RELATED APPLICATIONS

This application is a US National Stage of International Application No. PCT/EP2012/000738, filed 20 Feb. 2012, which claims the benefit of DE 10 2011 012 130.7, filed 23 Feb. 2011, both herein fully incorporated by reference.

### BACKGROUND OF THE INVENTION

1. Field of Invention

The present invention relates to a lighting device, in particular in the form of a ceiling, wall or floor light or outside light for the illumination of parks, walkways or streets, having a punctiform light source, preferably in the form of an LED, and a lens assigned to the light source, which has a light entry recess in the form of a bowl or blind hole, which directs at least part of the incident light, indirectly or directly, onto a totally reflecting and/or mirrored lateral surface, which in turn directs the light onto a light exit surface, which forms a front side of the lens located opposite the light entry recess.

2. Background and Related Art

Ceiling-mounted spotlights or so-called downlights are relatively small-sized spotlights, regularly installed in or attached or mounted on ceilings of buildings and ceiling or furniture panels, but which can optionally also be mounted suspended or pendulous and are designed to illuminate a limited space as uniformly as possible. Said types of downlights can be used, for example, to illuminate tables from above in a targeted and uniform manner without disturbing the indoor ambience.

Attempts to use LEDs as light sources for these types of spotlights were recently under-taken, in order to utilize the known advantages of LEDs such as low energy consumption and durability also for this area of application or segment of lights. However, this is not possible by implication, because they produce a relatively large amount of heat and thus cooling devices are required, greatly increasing the installation height of these types of spotlights at the top or back side, such that the ceiling-mount is almost no longer possible. But the safe operation is virtually impossible without these types of cooling components at the back of the LED.

Secondly, the light quality achievable in this fashion has often not been satisfactory in the past. Specifically, irregularities such as bright spots or color stains appear on the illuminated surface. Yet, the procedures adoptable in principle to counter this phenomenon are restricted by the fact that the appearance of the corresponding spotlights should resemble the traditional downlights even with the use of LEDs as light sources as closely as possible both in turned off and turned on status, in order to achieve sales acceptance and to satisfy the demands concerning the room design.

A built-in ceiling spotlight is shown for instance in DE 20 2007 007 046 U1, for which an LED is to be provided as light source with a reflector arranged behind it recessed in the ceiling for the targeted deflection of the light. In addition, light transmission rings projecting beyond the installation surface are provided to deflect the light emitted by the LED not only downward, but also sideways along the ceiling. A built-in spotlight with an LED as light source is likewise shown in DE 20 2009 005 777 U1, wherein the LED is to be arranged in the focal point of the reflector. A cooling unit mounted at the back of the reflector is integrated in the spotlight casing in the form of a thin plate, whereby sufficient cooling is only possible with lower outputs. In addition, an LED downlight with the LED inserted into the reflector from the back is shown in KR 100946548 B1.

EP 20 31 296 A1 shows a lighting device having an LED as light source integrated into a ceiling panel, with a lens arranged in front of the light source to completely capture and focus the light emitted by the LED onto a focal point. As a result, the light exit opening to be provided in the ceiling panel can be very small, because the light is focused through it. However, this design of the lighting device no longer coincides with the optical appearance of a traditional downlight. Moreover, the traditional installation used with traditional downlights is impossible.

### BRIEF SUMMARY OF THE INVENTION

Briefly described, in a preferred form, the present invention comprises an improved lighting device of the type mentioned above, which prevents the disadvantages of the prior art and upgrades the latter in an advantageous fashion. Specifically, a compact spotlight in the shape of a downlight is to be created, which allows a uniform illumination of the surface to be illuminated without irregularities and heat-related problems in spite of the use of an LED as light source, while being insensitive to work tolerances and position tolerances with respect to the arrangement of the light source relative to the lens.

According to the invention, this object is solved with a lighting device having a punctiform light source, preferably in the form of an LED, and a lens assigned to the light source, said lens having a light entry recess in the form of a bowl or blind hole, which directs at least part of the incident light, directly or indirectly, onto a totally reflecting and/or mirrored lateral area of the lens, which in turn directs the light onto a light exit surface by means of total reflection and/or reflection, said light exit surface forming a front side of the lens located opposite the light entry recess, characterized in that the lateral area of the lens is provided with a plurality of facets shaped such that the light beams deflected by the lateral area cross one another even before reaching the light exit surface.

Thus, it is proposed to mix the light emitted by the punctiform light source or its light beams already near the lens and/or close to the light exit area, such that irregularities in the illuminated area are prevented. According to the invention, the lateral surface of the lens which directs the incident light coming from the light entry surface onto the light exit surface by means of total reflection and/or mirroring is equipped with a plurality of facets. The surface structure of the totally reflecting and/or mirrored lateral surface in the form of faceting ensures that the deflected light beams are crossing one another, i.e., that deflected light beams in turn are crossing deflected light beams and the light is mixed such that irregularities of the illuminated area including light spots and color stains can be prevented. In so doing, the facets are shaped such that the light beams deflected by the lateral surface or the facets provided thereupon are crossing one another even before reaching the light exit surface of the lens such that the light beams are already mixed near the lens. The superimposition or crossing over of the light beams within the lens refers to the rays emitted from a theoretically ideal, in effect punctiform light source in which all light beams actually originate from a mathematical point and does not only mean crossovers originating from a light source of finite divergence by the emission of light beams from different points. A homogenous illumination of high lighting quality of the illuminated surface of the area of the room to be lit can be achieved. At the same time, an optically appealing appearance resembling traditional downlights is achieved, whereby a low installation height can nevertheless be complied with which allows a traditional ceiling, wall or floor installation of the light.

The faceting of the lateral surface and the corresponding deflection of the rays on the inside of the lens renders the lighting device tolerant or insensitive to manufacturing tolerances of the lens as well as to position tolerances concerning the relative arrangement of the light source to the lens. Incorrect positioning of the light source relative to the lens has no or only a minor impact on the light mixing and the homogeneous illumination of the space to be lit up as intended, because a particular light path almost always hits the matching inclined section of the lateral surface on which it is deflected accordingly, even in the case of tolerances, because of the plurality of facets. A high quality optical homogeneous characteristic light distribution is achieved in the target area.

In order to achieve a particularly efficient mixing of the light captured from the light source, the mentioned facets can have an arched surface deviating from a flat surface in an up-grade of the invention. The faceted areas can generally have a convex curvature such that the lateral surface has a knob-like structure. In an advantageous upgrade of the invention, faceted areas with a slightly concave curvature can in particular also be provided, whose surface outline corresponds at least approximately to the impression of flat lenses. The desired total reflection on the lateral surface along with a relatively high degree of freedom with respect to the outline of the lateral surface can be obtained to a great extent with said types of concave facets, while a particularly thorough mixing of the light is achieved at the same time.

Hereby, the facets can likewise have mixed forms of the curvatures and surface outlines mentioned above, for example such that one facet comprises a concave section and a convexly curved section, or also a concave section and/or a convex section combined with a flat, almost level faceted section. In an upgrade of the invention, free-form facets can also be provided, whose outline does not coincide with any basic mathematical shape. This allows a very variable control of the desired deflection angles on the facets, whereby a high degree of light mixing and at the same time a high degree of freedom of the lateral surface outline is achieved.

In order to achieve the desired effect of uniformity to a high degree, while on the other hand however maintaining the total reflection at the lateral surface, not only a lower number of large-size facets, but a large variety of small-size facets can be provided on the lateral surface in an advantageous upgrade of the invention. Depending on the size of the lens, the number of facets can vary or be adjusted to the optical effect to be achieved. For lens sizes common in downlights, more than 100, preferably also more than 200 facets can be distributed across the lateral surface in an advantageous upgrade of the invention, whereby essentially the entire lateral surface—optionally excluding the edges—is advantageously equipped with faceting. The distribution and/or shape of the facets can basically vary, wherein the facets are advantageously arranged in a regular pattern, which can, for example, comprise five or more rings of facets, each having at least twelve facets, provided superimposed on the lateral surface. Preferably, the same number of facets are provided in every ring of facets, even though the diameter increases in size toward the light exit side of the lens, such that all in all a harmonious, uniform pattern is achieved which attains uniform mixing.

In order to achieve thorough mixing of the light beams and a high degree of uniformity of the light distribution, the lateral surface and the facets provided thereon are designed such in an upgrade of the invention that the light beams deflected from the lateral surface are crossing one another before reaching the light exit surface. This can basically be achieved with different facet outlines, wherein facets with a light curvature are particularly suitable in this respect.

In an advantageous upgrade of the invention, the lens emits light beams that have been deflected different numbers of times, namely light beams deflected at the lateral surface by means of total reflection on the one hand and light beams aimed directly onto the light exit surface from the light entry surface of the lens on the other hand. For this purpose, the light entry recess in the form of a bowl or blind hole mentioned above can comprise a central entry zone in an upgrade of the invention, which directly aims the incident light onto the light exit surface, and additionally an outer entry zone preferably directly adjacent to the mentioned central entry zone which directs the incident light beams arriving there onto the mentioned faceted lateral surface.

Alternatively or additionally, the lens can also be designed such that at least part of the light beams directed from the light entry surface of the lens onto the light exit surface of the lens are initially deflected there, i.e., at the light exit surface and directed onto the lateral surface mentioned above. From the mentioned total reflecting and/or mirrored lateral surface, the light beams are then projected back onto the light exit surface of the lens and subsequently emerge from there. Hereby, at least part of the light exit surface of the lens can be designed totally reflecting with respect to the light beams originating from the light entry surface, in order to direct the light beams onto the lateral surface by means of total reflection. The light beams projected back onto the light exit surface from the lateral surface can nevertheless emerge from there, provided they are directed onto the mentioned light exit surface with an adequately steep angle. Alternatively or additionally, the light exit surface can likewise comprise a mirrored area, preferably a central mirrored area such that at least part of the incident light beams are directed from the light entry surface onto the mentioned mirrored area, where they are deflected and directed onto the lateral surface and directed onto an unmirrored area of the light exit surface by the totally reflecting and/or mirrored lateral surface, from where they subsequently emerge from the lens. Thus, at least part of the light captured by the entry surface of the lens is aimed directly onto the lateral surface of the lens mentioned above in order to be directed from there onto the light exit surface such that the light beams deflected by the lateral surface can emerge from the lens. This is also how the facets provided on the lateral surface can achieve a particularly effective mixing of the light within the lens.

The light entry surfaces and the faceted lateral surface of the lens are preferably designed such that the light beams deflected by the lateral surface cross the light beams directed from the light entry surface onto the light exit surface before reaching the light exit surface. This helps achieve a further improvement of the desired mixing and uniformity.

Preferably, the faceted lateral surface hereby directs the light beams onto at least 50%, preferably more than 75% of the entire light exit surface, i.e., the light beams deflected by the lateral surface are distributed onto the entire light exit surface or at least onto a substantial part thereof. In an advantageous upgrade of the invention, the light beams aimed directly onto the light exit surface are likewise distributed at least onto a central area of the light exit surface, whose diameter amounts to at least ¾ of the diameter of the entire light exit surface.

However, different configurations can also be provided, depending on the desired illumination effect for the area to be illuminated.

In an upgrade of the invention, the lens as a whole can have a completely flattened and/or strongly expanding, in particular conical shape, such that the rays reflected on the faceted lateral surface are distributed onto a relatively large light exit surface, wherein the lateral surface likewise takes up a relatively large area and a corresponding number of facets can be provided. For example, the lateral surface of the lens can expand under a cone angle in the range of 2×40° to 2×80°, preferably about 2×50° to 2×70°, wherein the mentioned cone angle should be considered approximate because of the faceting and can be measured, for example, with the application of a tangent to the faceted lateral surface, when viewed in cross-section.

In an upgrade of the invention, the lens with its faceted lateral surface can form a light spot splitting device, which splits the light emitted by the light source into a plurality of individual light spots, in particular such that every receiving point of the surface to be illuminated or every point of the space to be illuminated is lit up by at least 25, preferably at least 50, in particular more than 100 separately distinguishable light spots. Looking at the lens from the area to be illuminated as intended or from the space to be lit up, the lens exit surface does not appear as a uniformly bright surface, but the mentioned plurality of separately discernible light spots is visible on the lens.

In the process, the lens, in particular its faceting can be designed such that the largest dimension D of every separately discernible illuminated panel on the lens projected into the viewing direction is defined by the following relation:

D≦2·a·tan(x/2),

wherein a is the viewing distance, that is, the distance of the illuminated receiving point from the respective illuminated panel measured in meters and the following is true for the angle of beam spread x formed in the receiving point by the partial light bundle of the illuminated panel:

x=(−1/g·ln [(K−B)/(K−1)]−s,

wherein the angle of beam spread x is stated in angular minutes (with angular minute=1/60° with 360°=circle) and the following inequalities apply to the parameters g, K, b and s

0.5≦g≦0.9

6≦K≦9

1≦B≦5.8

0≦s≦0.3

and, additionally, the minimum distance between adjacent illuminated panels projected into their viewing direction is defined by the relation:

b=2·a·tan(y/2),

wherein the viewing distance a is measured in meters and y≦10 angular minutes, wherein y is the angle of beam spread formed by the adjacent partial light bundles of two illuminated panels.

In an advantageous upgrade of the invention, the central entry surface of the light entry recess mentioned above can have a bowl-shaped curvature, wherein different degrees of curvature can be provided depending on the desired level of divergence of the light beams aimed directly at the light exit surface. The mentioned curvature of the central entry zone can be designed convex toward the LED, but in particular a concave curvature of the mentioned central entry zone can preferably also be advantageous. Alternatively or additionally, the diameter of the outer entry zone arranged adjacent to the edge of the central entry zone can advantageously expand away from the central entry zone, wherein, in particular, a coniform design of the mentioned outer entry zone can be provided.

In an upgrade of the invention, the mentioned central light entry surface can also be equipped with faceting to achieve a better mixing of the light, wherein said faceting can be provided on the mentioned central light entry surface alternatively or additionally to the faceting on the lateral surface.

In contrast to the faceted lateral surface of the lens, the light exit surface is designed without facets and smooth in an advantageous upgrade of the invention. On the one hand, this helps achieve a clear visual appearance resembling traditional downlights. However, the optical effect of said type of smooth light exit surface is more important. In an advantageous upgrade of the invention, the smooth light exit surface of the lens can have a minor, preferably convex curvature and/or be designed such in combination with the outline of the lateral surface and the light entry surface of the lens that the light beams deflected from the lateral surface onto the light exit surface are crossing one another once again after emerging from the light exit surface and are likewise crossing the light beams aimed directly onto the light exit surface after emerging from the light exit surface. Further mixing and uniformity can be achieved in this fashion.

To facilitate the installation into ceiling panels or ceilings in a traditional manner in spite of the cooling media to be provided for the LEDs, the lens in front of the LED has a relatively flat design in an advantageous upgrade of the invention, wherein it can, in particular, be provided that a maximum lens diameter D is advantageously provided at the light exit surface which is larger than the maximum lens height, preferably amounting to more than about 125% of the lens height, wherein lens diameters D of more than 200%, optionally more than 500% of the lens height can be provided depending on the desired illumination.

To achieve the desired light mixing and divergence of rays in spite of the limited construction height of the lens, the diameter ratio of the lens can be selected accordingly in combination with the mentioned faceting of the lateral surface, wherein here a minimum lens diameter at the base of the lens on its light entry side is provided and can amount to less than ⅓ or also less than ¼, optionally also less than ⅕ of the maximum lens diameter at the light exit side in an advantageous upgrade of the invention. Depending on the design, different diameter ratios can be provided here, wherein it has been proven favorable to select the minimum lens diameter at the base of the lens in the range of about 10% to 50% of the maximum lens diameter.

Even though the light beams directed onto the lateral area of the lens are deflected there because of the geometry, i.e., the flat deflection angles selected analogous to the material, pre-dominantly by means of total reflection, it can be provided in an upgrade of the invention to apply a reflecting or mirrored coat to the lateral area of the lens. A complete deflection onto the light exit surface of the lens can be ensured in this manner and an undesirable light exit on the side prevented. At the same time, a greater degree of freedom can be achieved for the lens design and the outline of the lateral area.

To further alleviate the cooling-related problems, a flue or ventilation slot is provided between the outer lens surface and a surrounding light housing in an upgrade of the invention, which allows the circulation of a cooling air flow past the lens to the components of the light arranged behind the LED. In an upgrade of the invention, the mentioned lens and the punctiform light source, including a supplying carrier component which the light source is mounted on, are surrounded by a barrel-shaped housing part, which advantageously ends nearly flush on the front side with the light exit surface of the lens and is spaced from the lens by means of a ventilation slot across the entire lens height and essentially across the entire circumference of the lens.

To be able to use the mentioned barrel-shaped housing part simultaneously as positioning and installation aid, the mentioned barrel part can comprise a holding and/or mounting flange or ridge projecting outward on the end located close to the area of the light exit surface of the lens, with which the light can be mounted onto the edge of a built-in recess, for example, on a ceiling or a panel in an upgrade of the invention.

These and other objects, features and advantages of the present invention will become more apparent upon reading the following specification in conjunction with the accompanying drawing figures.

### BRIEF DESCRIPTION OF THE DRAWINGS

Various features and advantages of the present invention may be more readily understood with reference to the following detailed description taken in conjunction with the accompanying drawings, wherein like reference numerals designate like structural elements, and in which:

FIG. 1: shows a top view of a lighting device in the form of a ceiling spotlight according to an advantageous embodiment of the invention, depicting the light exit surface of the lens and the barrel-shaped housing part spaced from the lens by means of a ventilation slot as well as its mounting flange;

FIG. 2: shows a schematic sectional view of the lighting device from FIG. 1, which illustrates the convection created by the barrel-shaped housing design for cooling the supply components for the LED, wherein one embodiment variant is shown with internal convection;

FIG. 3: shows a schematic sectional view of the lighting device from FIG. 1 in a representation similar to the one in FIG. 2, wherein a housing variant with exterior convection for cooling the supply components of the LED is illustrated;

FIG. 4: shows a perspective view of the lighting device lens from the preceding figures, wherein the lens is shown diagonally from the front with the light exit surface and diagonally from the back with the light exit recess in the partial views (a) and (b);

FIG. 5: shows a side view of the lens from FIG. 4, which illustrates the outline of the light exit surface as well as the lateral area with the proposed faceting on it;

FIG. 6: shows a sectional view of the lens from the preceding figures along the line G-G in FIG. 5, wherein the course of the faceting is shown in detail I of FIG. 6;

FIG. 7: shows a sectional view of the lens from the preceding figures along the line H-H in FIG. 5, wherein the course of the faceting is illustrated in the detailed view J of FIG. 7;

FIG. 8: shows a longitudinal section through the lens from the preceding figures;

FIG. 9: shows a schematic longitudinal view through the lens from the preceding figures, with the passage of the light beams for a point light source plotted on it to emphasize the crossing over of the primary and secondary light beams;

FIG. 10: shows a schematic perspective view of a lens of a lighting device according to a further advantageous embodiment of the invention, wherein the lens has a rectangular exterior outline and is provided with faceting on its lateral area, wherein
the partial view (a) shows the light exit surface of the lens and partial view (b) the faceted lateral area;

FIG. 11: shows a side view of the lens from FIG. 10;

FIG. 12: shows a side view of the lens from FIG. 10 and FIG. 11 along the line B-B in FIG. 11;

FIG. 13: shows a cross-section through the lens from the preceding figures along the line A-A in FIG. 11, wherein the partial view (a) shows the entire section and the partial view (c) the course of the facets along the lateral area in an enlarged detailed view;

FIG. 14: shows a schematic sectional view of the lens from FIGS. 10-13 in a representation similar to the one in FIG. 11, in which the passage of the light beams is plotted to emphasize the repeated crossing over of the deflected light beams; and

FIG. 15: shows a schematic side view of the lighting device from the preceding figures in different installation situations, wherein the partial view (a) shows a pendulous suspension, the partial view (b) an add-on or assembly and the partial view (c) a recessed ceiling light; and

FIG. 16: shows a schematic illustration of the light spot splitting through the lens of the spotlight from one of the preceding figures.

### DETAILED DESCRIPTION OF THE INVENTION

To facilitate an understanding of the principles and features of the various embodiments of the invention, various illustrative embodiments are explained below. Although exemplary embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the exemplary embodiments, specif-ic terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

The exemplary embodiment of the lighting device 1 shown in the figures is designed as downlight or installable ceiling spotlight having an LED as light source 2, which can be mounted on the circuit board 6 of a supply part to ensure the control and power supply of the LED, but can also be supplied in a traditional fashion by means of a simple cable supply. A lens 3 roughly resembling a truncated paraboloid precedes the mentioned light source 2, the light entry side of said lens being arranged or positioned directly on the circuit board 6, whereby the lens 3 can have a small distance from the circuit board here.

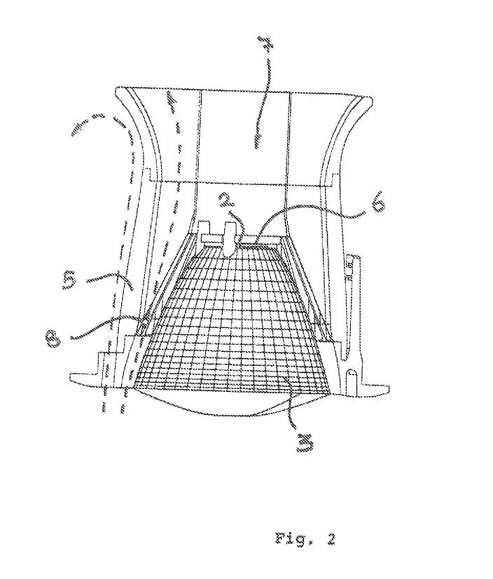

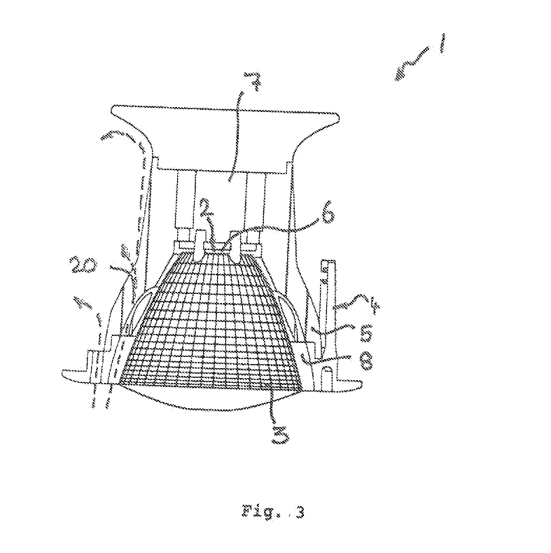

In the embodiment according to FIG. 2, the lens 3 as well as the light source 2 including the light part 7 arranged on the back are surrounded by a barrel-shaped housing part, one of the front ends of which ends in the area of the light exit surface 16 of the lens 3, cp. FIG. 2 and extends across the entire height of the light, wherein a ventilation slot is provided between the lens 3 as well as the light part 7 on the one hand and the barrel-shaped housing part 5 on the other hand, to facilitate the internal convection for cooling the heat-relevant components of the light.

Alternatively to the embodiment illustrated in FIG. 2, the barrel-shaped housing part 5 can likewise end in the region of the transition between the lens 3 and the light part 7 positioned at the back behind the LED or be drawn inward toward the light part 7 and comprise passage 20 in the mentioned area, to allow the air flow entering through the ventilation slot 8 between the lens 3 and housing part 5 to escape from the housing part 5 and induce an external convection for cooling the light, cp. FIG. 3.

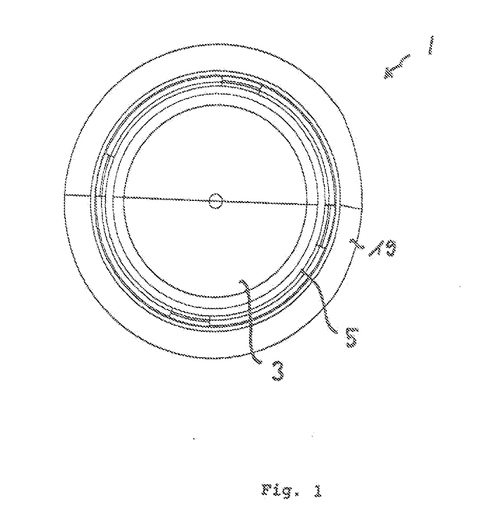

A mounting ridge 19 radially projecting outward is additionally provided at the frontal end of the barrel-shaped housing part 5 in the region of the light exit side of the lens 3, said mounting ridge likewise being spaced from the main portion of the housing part 5 by means of a gap, cp. FIGS. 1 to 3, and being connected with the main part of the housing part 5 by means of individual ridges. The mentioned mounting ridge 19 can be mounted onto the retaining recess, for example, in a ceiling panel or similar, as illustrated in FIG. 1.

On its light entry side, the lens 3 placed over the light source 2 comprises a light entry recess 9 in the form of a blind hole which delimits a hollow space in which the light source 2 is arranged, cp. FIG. 8. The mentioned light entry recess 9 is advantageously divided into two zones, wherein a central entry zone 10 forms the bottom of the blind hole-like light entry recess 9 and has a slightly concave design in the drawn embodiment.

The outer entry zone 11 bordering onto the central entry zone 10 forms an internal lateral area of the light entry recess 9 and has a slightly spread out conical shape in the drawn embodiment such that the light entry recess 9 is tapered from the light source 2 to the central entry zone 10, cp. FIG. 8.

The lens body made of a transparent solid material arranged opposite the mentioned light entry recess 9 comprises a light exit surface 16 which forms the opposing front side of the lens 3 and has a spherical shape in the drawn embodiment, in particular a bowl-shaped convex curvature. The mentioned light exit surface 16 has a smooth design without facets or surface structures.

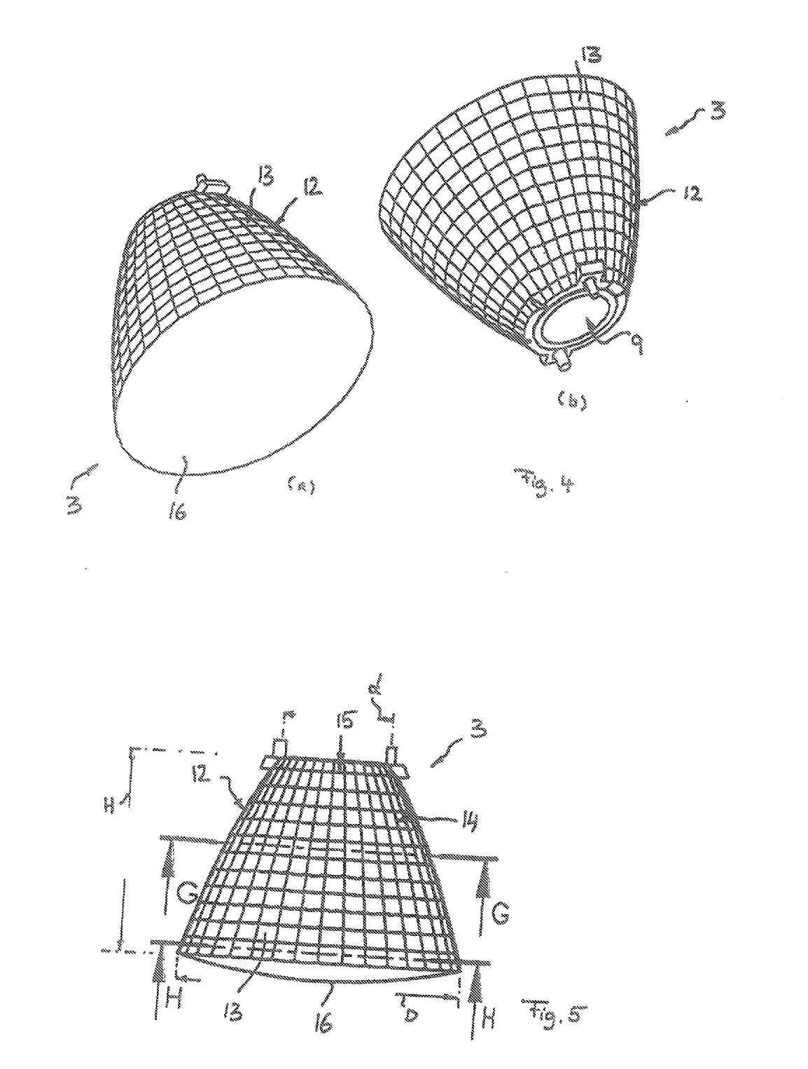

Between the mentioned light exit surface 16 and the light entry recess 9, the lens 3 is delimited on the peripheral side by a lateral area 12, the cross-section or diameter of which expands from the light entry side toward the light exit surface 16 and also has a slightly spherical shape such that the lateral area 12 has a slightly parabolic cross-section, cp. FIGS. 5 and 8. In the drawn embodiment according to FIG. 5, the selected ratio of the maximum diameter D on the light exit surface 16 of the lens 3 to the minimum diameter d of the lens 3 at its base in the region of the light entry recess 9 is approximately 7:3, wherein however different diameter ratios can be selected here, depending on the kinds of irradiation ratios the ceiling spotlight should achieve. In the drawn embodiment, cp. FIG. 8, the lens height H is approximately 5/7 of the maximum lens diameter D.

As illustrated in FIGS. 5 to 7, the mentioned lateral area 12 is provided with a surface structure in the form of faceting, having a plurality of facets 13. The mentioned facets 13 are distributed across the entire lateral area 12 in a regular pattern and are essentially arranged directly adjacent to one another such that the entire lateral area 12 is faceted. Advantageously, the facets 13 can be arranged superimposed on one another in a plurality of rings surrounding the periphery, wherein the facets can be arranged directly superimposed on one another as drawn in FIG. 5, or also slightly offset from one another in the direction of the circumference. In the embodiment drawn in FIG. 5, twelve rings of facets are provided superimposed on one another, wherein the same number of facets 13 is provided in every ring 14, wherein more than 24 facets, preferably also more than 36 facets can be provided here in every ring 14.

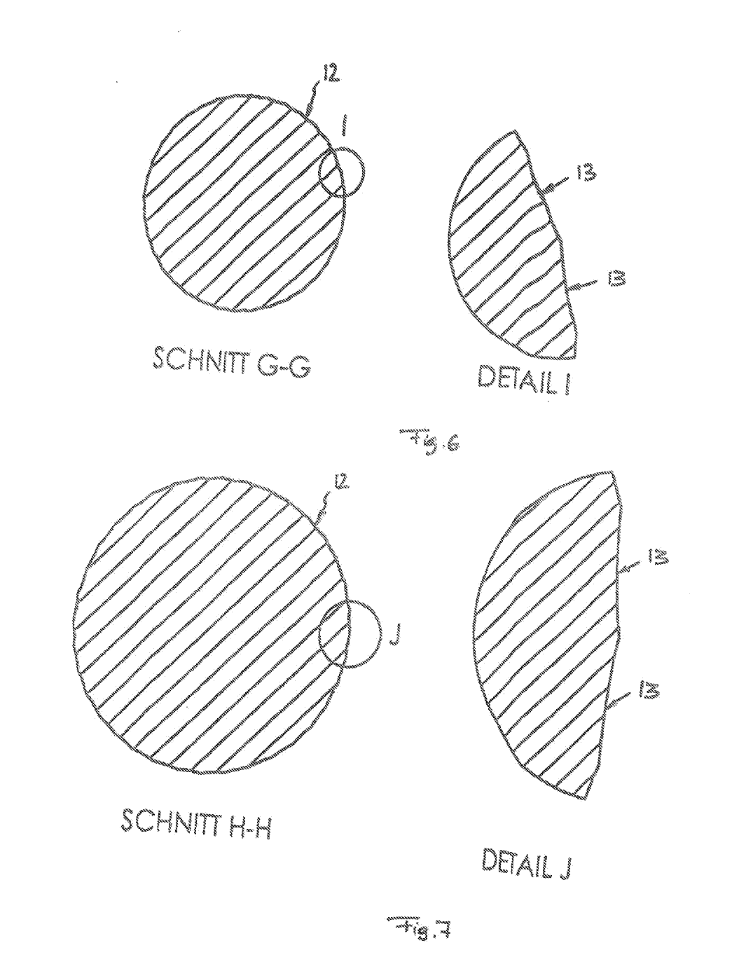

As shown in FIGS. 6 and 7, the facets 13 have a slightly concave design such that the facets 13 resemble the impression of flat lenses.

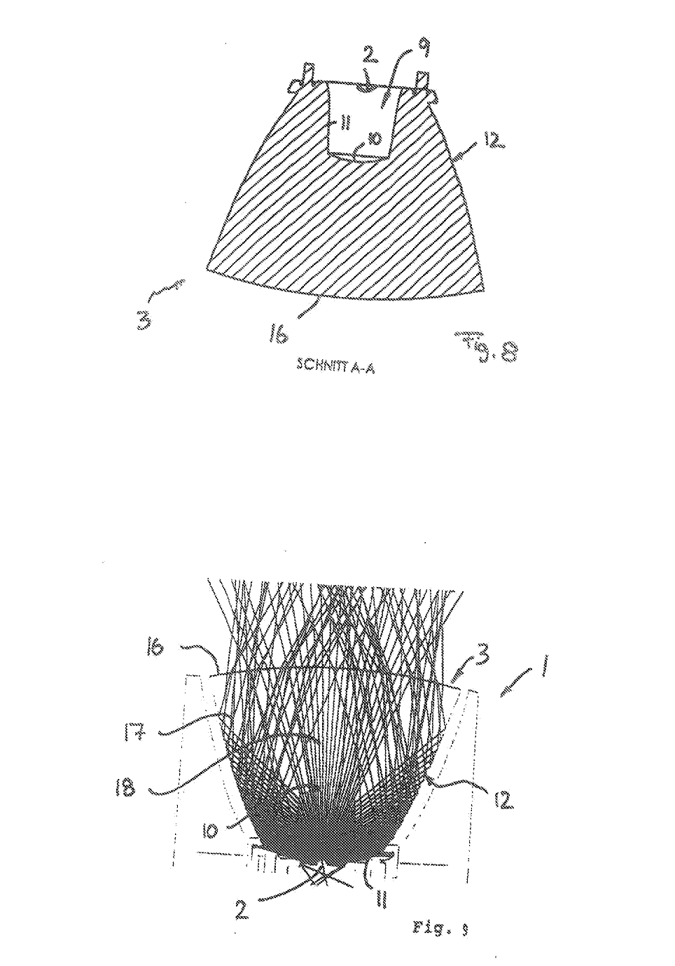

The geometry of the lens and the facets 13 is advantageously selected such that the light beams running within the lens 3 and the light beams emerging from the lens 3 cross one another. As shown in the embodiment according to FIG. 9, the light emitted by the punctiform light source 2 which is positioned in the area of the light entry recess 9, is completely captured by the lens 3. The light beams illustrated in FIG. 9 are based on a mathematical point, i.e., an idealistic, actually punctiform light source. The two entry zones 10 and 11 of the light entry recess 9 thus deflect the captured light differently. The light captured by the central entry zone 10 is aimed directly onto the light exit surface 16, whereby said directly deflected light is aimed onto a larger or smaller central sub-area of the light exit surface 16, cp. the direct light beams 18 in FIG. 9. Meanwhile, the part of light of the light source 2 captured by the outer entry zone 11 is directed onto the lateral area 12 of the lens 3 and deflected from the lateral area 12 and the facets 13 provided thereon onto the light exit surface 16 by way of total reflection. Said secondary or totally reflected light beams 17 are essentially distributed onto the entire light exit surface 16, whereby the faceting 13 achieves that the totally reflected light beams 17 already cross one another before reaching the light exit surface 16 and additionally also cross the direct light beams 18 even before reaching the light exit surface 16. Moreover, the totally reflected light beams 17 likewise cross both one another as well as the emerging direct light beams 18 after exiting the light exit surface 16.

All in all, a strong, efficient mixing of light can be achieved in this fashion, whereby light irregularities such as light spots and color stains on the illuminated area are prevented.

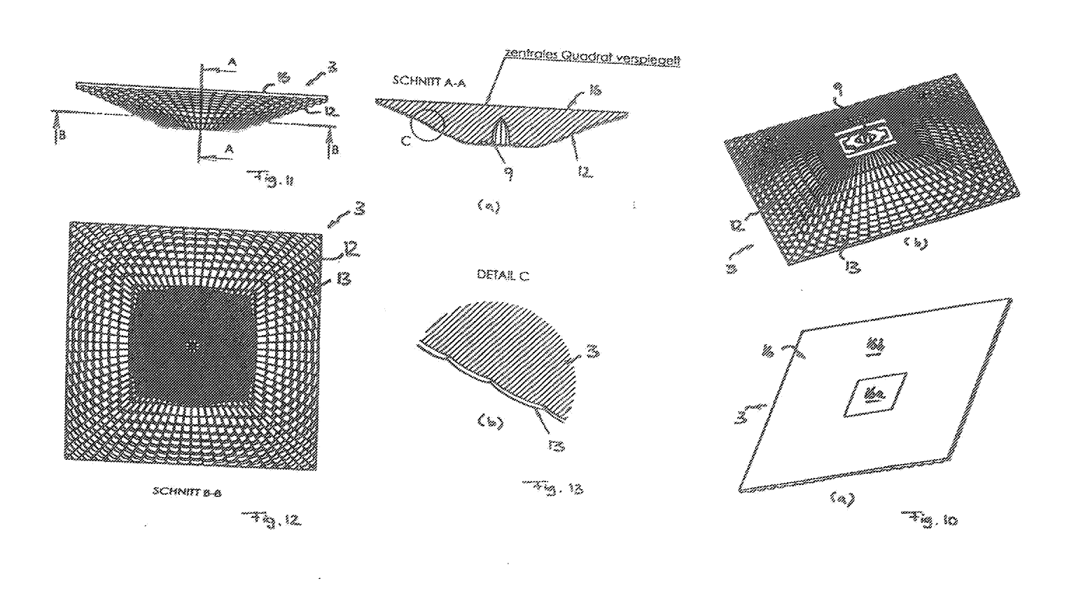

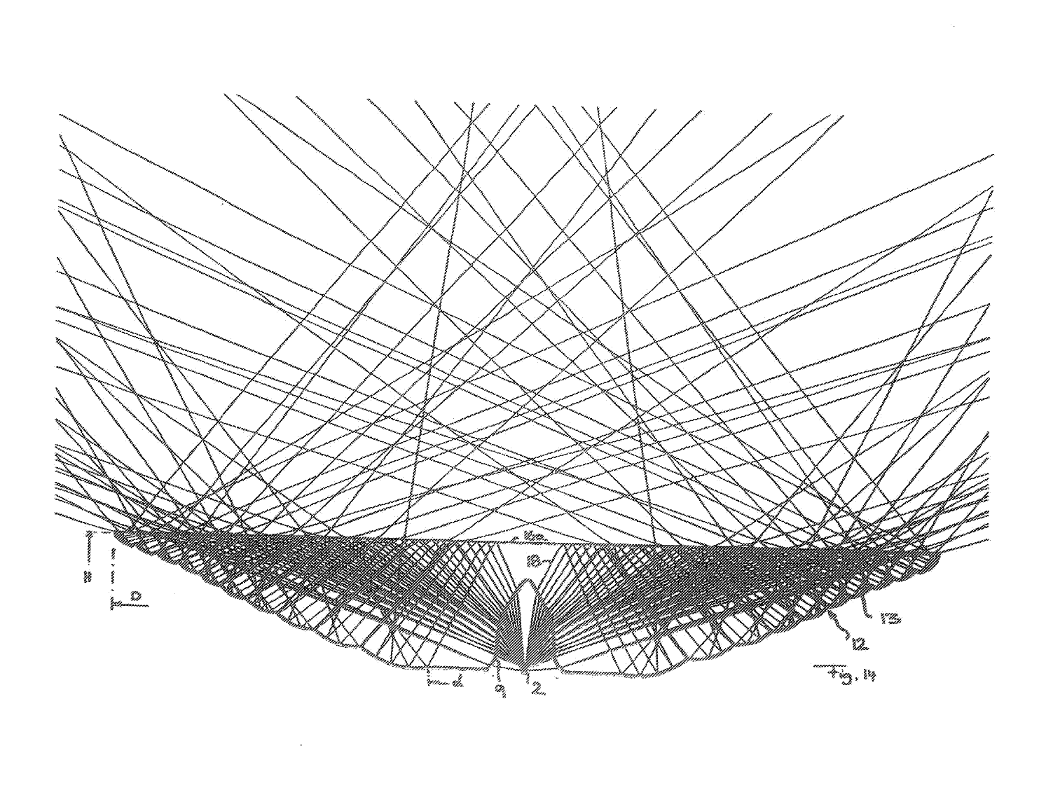

As illustrated in FIGS. 10-14, the light beams entering the lens corpus from the light source 2 can also be aimed indirectly onto the faceted lateral area 12, namely in particular by way of the light exit surface 16 of the lens to achieve an additional crossing over of the ray paths and a corresponding mixing of the light by means of additional deflection.

The lens 3 shown in FIGS. 10-14 has a rectangular external outline and an essentially rectangular light exit side, cp. FIG. 10, wherein the light exit surface 16 in the drawn embodiment has a flat and facet-free design overall, but optionally might also have a bowl-shaped curvature. All in all, the lens 3 according to FIGS. 10-14 is designed much lower and has a much greater diameter-to-height ratio. In the drawn embodiment, the maximum lens diameter D in the area of the light exit surface 16 is more than five times the amount of the height H of the lens, cp. FIG. 14 and also more than double the size of the minimum lens diameter d in the area of the light entry side. However, different dimensional ratios can be selected here as well, depending on the illumination task.

Similar to the embodiment described above, the lens 3 comprises a central light entry recess 9, which delimits a hollow space for retaining the light source 2. Viewed as a whole, the mentioned light entry recess 9 has a harmonious curved design and is approximately—roughly speaking—conical, but advantageously matching the rectangular exterior outline according to the type of a pyramid, cp. FIG. 10(b). More precisely, the mentioned light entry recess 9 is designed such that the light beams captured from the light source 2 are first directed completely onto the light exit surface 16 of the lens 3. The mentioned light exit surface 16 has a mirrored design in a central area 16a, cp. FIG. 10(a), such that the light beams directed to there are reflected back and directed onto the lateral area 12. Around the central mirrored area 16a, the light exit surface 16 has an unmirrored design, but it is totally reflecting with respect to the light beams coming from the light entry recess 9, because said rays are hitting said exterior area 16b of the light exit surface 16 under a correspondingly flat angle. Accordingly, the light beams initially directed onto the light exit surface 16 from the light entry side are deflected and cast onto the lateral area 12.

The mentioned lateral area 12 has a mirrored design and is equipped with faceting comprising a plurality of facets 13, which in turn are arranged essentially across the entire lateral area 12 in a regular pattern, similar to the embodiment described above. The mentioned facets 13 are shown in more detail in FIG. 13(b), wherein the mentioned facets can, in particular, have a spherical or convex design, cp. FIG. 13 and FIG. 14.

The light beams aimed indirectly onto the lateral area 12, namely via the light exit surface 16, are projected back onto the light exit surface, namely onto the unmirrored area 16b of the light exit surface 16 mentioned above from the lateral area 12 because of the mirrored surface coat applied thereupon, optionally also by way of total reflection. Advantageously, the lateral area and the faceting provided thereupon are designed such that the light beams deflected from the lateral area 12 are essentially distributed completely onto the unmirrored area of the light exit surface 16.

The light beams directed from the lateral area 12 onto the light exit surface 16 hit the light exit surface there under a sufficiently steep angle such that they can emerge there under corresponding deflection, cp. FIG. 14.

As a result, the light beams cross one another several times within the lens 3: as illustrated in FIG. 14, the primary light beams 18, which are directed from the light entry surface onto the light exit surface 16, are first crossed by the light beams reflected back there or directed onto the lateral area 12. The light beams reflected back onto the light exit surface 16 from the lateral area 12 are again crossing both the primary light beams 18 mentioned above as well as the light beams reflected back from the light exit surface 16, even before the light beams emerge from the light exit surface 16. Moreover, the light beams 16 are crossing one another once again after emerging from the light exit surface, cp. FIG. 14.

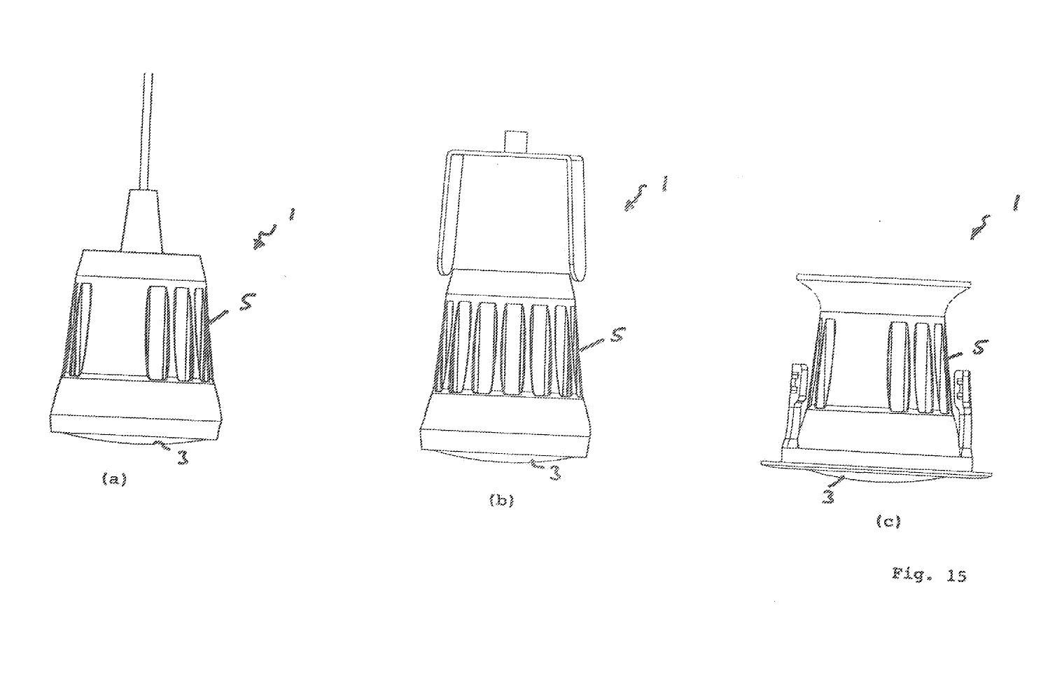

As shown in FIG. 15, the light can be used in different installation situations, wherein the barrel-shaped housing part 5 can advantageously be adapted to the different installation situations. For this purpose, the housing part 5 comprises different connecting faces for differently designed retaining and mounting means. According to the partial view (a) of FIG. 15, the light can be suspended pendulous, wherein here a pendulum suspension for example in the form of a centrically hinged self-aligning bearing can advantageously be mounted on the back end of a connecting face of the housing part 5 provided there. According to the partial view (b) of FIG. 15, it is likewise possible to attach a preferably bendable or rotatable retaining clip on the back end of the barrel-shaped housing part 5, which can be mounted on a suitable light mount such as a column or similar. However, as illustrated in partial view (c) of FIG. 15, a radially projecting mounting ridge can optionally be attached on the frontal end section of the housing part 5, in order to be able to mount the light in a ceiling recess or sunk-in in a ceiling panel such that the mentioned mounting ridge is flush with the edge of the installation recess.

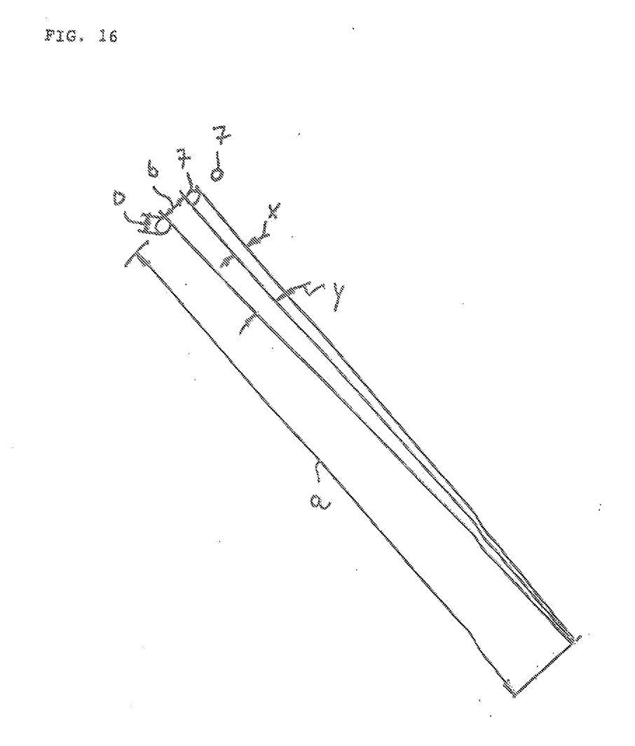

In an advantageous upgrade of the invention, light spot splitting illustrated in FIG. 16 can be achieved with the relatively strongly flattened outline of the lens illustrated for example in FIGS. 10-14. The design of the lens, in particular, its faceting, brings about light spot splitting, which facilitates a high-contrast perception of the areas to be illuminated on the one hand and extensive antiglare properties on the other hand. In so doing, every receiving point in the lit up room is illuminated by a plurality of separate discernible light spots. The design of the lens is such that it conforms to the relation illustrated in FIG. 16, according to which the light spots formed by the working face of the free-form lens conform to requirements for reasonable light point splitting with respect to the size and arrangement. This is characterized in that the largest dimension D of every light spot is defined with the following relation:

D≦2·a·tan(x/2),

wherein a is the viewing distance, that is, the distance of the receiving point from the respective illuminated panels measured in meters and the following applies for the angle of beam spread x formed at the receiving point by the partial light bundles of the illuminated panel:

x=(−1/g·ln [(K−B)/(K−1)]−s,

wherein the angle of beam spread x is indicated in angular minutes (with 1 angular minute=1/60 degrees with 360 degrees=circle) and the following inequalities apply to the parameters g, K, B and s

0.5≦g≦0.9

6≦K≦9

1≦B≦5.8

0≦s≦0.3

and additionally the minimum distance between adjacent illuminated panels is defined by the relation:

b=2·a·tan(y/2),

wherein a is the viewing distance measured in meters and y≧10 angular minutes, wherein y is the angle of beam spread created by the adjacent partial light bundles of two illuminated panels.

In so doing, parameters B and K mentioned above are sufficiently different from one another. Advantageously, parameter B is selected contingent upon the illumination power to be defined in the viewing distance a, where it affects the dazzling effect, wherein the parameter is preferably B≦5, in particular B≦4.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

1. A lighting device comprising a lens having a lateral area provided with a plurality of facets shaped such that light beams of a light source deflected by the lateral area cross one another before reaching a light exit surface forming a front side of the lens and located opposite a light entry recess of the lens.

2. The lighting device according to claim 1, wherein the facets have curved surfaces.

3. The lighting device according to claim 1, wherein more than 100 facets are formed on the lateral area, and
wherein the facets are arranged in a regular pattern comprising at least five rings surrounding the lateral area, each of the rings comprising at least twelve facets arranged superimposed on one another on the lateral area.

4. The lighting device according to claim 1, wherein the lateral area expands toward the light exit surface under an incline in the range of 2×40° to 2×80°.

5. The lighting device according to claim 1, wherein the lens with the facets forms a light point splitting device, which splits light emitted by the light source into a plurality of light spots such that every receiving point of the area to be illuminated is lit up by at least 25 separate discernible light spots.

6. The lighting device according to claim 5, wherein the largest dimension D of each separate discernible light spot of the light conforms to the following relation:
D≦2×a×tan(x/2),
wherein a is the viewing distance, that is, the distance of the receiving point from the respective illuminated panels in which the lighting device is installed measured in meters and the following applies to the angle of beam spread x created by the partial light bundles of the illuminated panel at the receiving point:
x=(−1/g×ln [(K−b)/(K−1)]−s,
wherein the angle of beam spread x is indicated in arc minutes and the following inequalities apply to the parameters g, K, B and s
0.5≦g≦0.9
6≦K≦9
1≦B≦5.8
0≦s≦0.3
and, additionally, the minimum distance of adjacent illuminated panels is defined by the relation:
b=2×a×tan(y/2),
wherein a is the viewing distance measured in meters and y is ≧10 angular minutes, wherein y is the angle of beam spread created by the adjacent partial light bundles of two illuminated panels.

7. The lighting device according to claim 1, wherein the light entry recess comprises a central entry zone that directly aims the incident light onto the light exit surface of the lens, and an external entry zone, that directs the incident light onto the lateral area of the lens, and
wherein the central entry zone of the light entry recess has a bowl-shaped curved design and the external entry zone forms an internal lateral area tapering toward the central entry zone and the light entry recess delimits a hollow space with the punctiform light source arranged in it.

8. The lighting device according to claim 1, wherein the light entry recess is shaped such that at least part of the incident light is aimed directly onto the light exit surface of the lens, and
wherein the light exit surface comprises a totally reflecting section from which the light coming from the light entry recess is directed onto the lateral area of the lens, which reflects the light back onto an area of the light exit surface from where the light beams emerge from the lens.

9. The lighting device according to claim 7, wherein the facets on the lateral area of the lens are designed such that at least part of the light beams deflected by the lateral area cross the light beams that are aimed from the entry zone directly onto the light exit surface even before reaching the light exit surface, and
wherein the light exit surface is designed such that the light beams directed from the lateral area onto the light exit surface cross the light beams aimed from the central entry zone directly onto the light exit surface and directly emerge from there, after emerging from the light exit surface.

10. The lighting device according to claim 1, wherein the light exit surface has a facet-free and smooth design.

11. The lighting device according to claim 1, wherein the light exit surface is designed such that the light beams directed from the lateral area onto the light exit surface cross one another after emerging from the light exit surface.

12. The lighting device according to claim 1, wherein the lighting device is in the form of one of a ceiling, wall, floor or outside light;
wherein the light source is a punctiform light source in the form of an LED; and
wherein the light entry recess is in the form of a bowl or blind hole the directs at least part of the incident light, directly or indirectly, onto the lateral area being a totally reflecting and/or mirrored area of the lens, which in turn directs the light from the light source onto the light exit surface via total reflection and/or reflection.

13. The lighting device according to claim 1, wherein one or both of the lateral area and the facets provided thereon are designed such that the light beams deflected by the lateral area are distributed on at least 75% of the entire light exit surface.

14. The lighting device according to claim 1, wherein the maximum lens diameter is reached at the light exit surface and is larger than the maximum lens height.

15. The lighting device according to claim 1, wherein the lens and the punctiform light source include a supply component supplying the light source which the light source is mounted on, are surrounded by a barrel-shaped housing part,
wherein the barrel-shaped housing part ends nearly flush with the light exit surface of the lens and is spaced from the lens across the entire lens height by means of a ventilation slot, and
wherein the barrel-shaped housing part comprises connecting faces for connecting different retaining and/or mounting means for optional ceiling and/or panel installation, for the pendulous suspension and/or for add-on or assembly on a carrier element.

16. The lighting device according to claim 1, wherein the lens is designed such that the light cone emitted by the light exit surface has an angle of reflection of 2×5° to 2×80°.

17. A lighting device having a lateral area provided with a plurality of facets shaped such that light beams of a light source deflected by the lateral area cross one another before reaching a light exit surface forming a front side of the lens and located opposite a light entry recess of the lens; and
wherein at least a portion of the facets comprise concavely curved surfaces.

18. The lighting device according to claim 17 comprising more than 100 facets; and
wherein at least a portion of the facets are arranged in a regular pattern comprising at least five rings surrounding the lateral area, each of the rings comprising at least twelve facets arranged superimposed on one another on the lateral area.

19. The lighting device according to claim 18, wherein the lateral area expands toward the light exit surface under an incline in the range of 2×50° to 2×70°,
wherein the lens with the facets forms a light point splitting device, which splits light emitted by the light source into a plurality of light spots such that every receiving point of the area to be illuminated separate discernible light spots,
wherein the light entry recess comprises a central entry zone that directly aims the incident light onto the light exit surface of the lens, and an external entry zone that directs the incident light onto the lateral area of the lens,
wherein the central entry zone of the light entry recess has a bowl-shaped curved design and the external entry zone forms an internal lateral area tapering toward the central entry zone and the light entry recess delimits a hollow space with the punctiform light source arranged in it,
wherein the light entry recess is shaped such that at least part of the incident light is aimed directly onto the light exit surface of the lens, and
wherein the light exit surface comprises a totally reflecting section from which the light coming from the light entry recess is directed onto the lateral area of the lens, which reflects the light back onto an area of the light exit surface from where the light beams emerge from the lens.

20. The lighting device according to claim 19, wherein the facets on the lateral area of the lens are designed such that at least part of the light beams deflected by the lateral area cross the light beams that are aimed from the entry zone directly onto the light exit surface even before reaching the light exit surface,
wherein the light exit surface is designed such that the light beams directed from the lateral area onto the light exit surface cross the light beams aimed from the central entry zone directly onto the light exit surface and directly emerge from there, after emerging from the light exit surface,
wherein the light exit surface has at least one mirrored section and at least one unmirrored, non-reflecting section,
wherein the light exit surface is designed such that the light beams directed from the lateral area onto the light exit surface cross one another after emerging from the light exit surface,
wherein the lighting device is in the form of one of a ceiling, wall, floor or outside light,
wherein the light source is a punctiform light source in the form of an LED,
wherein the light entry recess is in the form of a bowl or blind hole the directs at least part of the incident light, directly or indirectly, onto the lateral area being a totally reflecting and/or mirrored area of the lens, which in turn directs the light from the light source onto the light exit surface via total reflection and/or reflection,
wherein one or both of the lateral area and the facets provided thereon are designed such that the light beams deflected by the lateral area are distributed on at least 75% of the entire light exit surface,
wherein the maximum lens diameter is reached at the light exit surface and is more than 125% of the lens height,
wherein the minimum lens diameter is reached at the base of the lens on the light entry side and amounts to less than 50% of the maximum lens diameter,
wherein the lens and the punctiform light source include a supply component supplying the light source which the light source is mounted on, are surrounded by a barrel-shaped housing part,
wherein the barrel-shaped housing part ends nearly flush with the light exit surface of the lens and is spaced from the lens across the entire lens height essentially by means of a ventilation slot,
wherein the barrel-shaped housing part comprises connecting faces for connecting different retaining and/or mounting means for optional ceiling and/or panel installation, for the pendulous suspension and/or for add-on or assembly on a carrier element wherein the barrel-shaped housing part comprises one or more of:
a radially outward projecting retaining,
a mounting ridge on its frontal end near the light exit surface of the lens,
a pendulum suspension on its back end, and
a bendable and/or rotatable retaining clip on its back end, and
wherein the lens is designed such that the light cone emitted by the light exit surface has an angle of reflection of 2×5° to 2×80°.
